(19) United States
(12) Patent Application Publication
(10) Pub. No.: US 2014/0297765 A1
(43) Pub. Date: Oct. 2, 2014

(54) PROFILING SOCIAL TRENDSETTERS

(71) Applicant: International Business Machines Corporation, Armonk, NY (US)

(72) Inventors: Kristina Beckley, Carlisle, MA (US); Josef Scherpa, Fort Colins, CO (US); Kate Seideman, Newton, MA (US); Erika Varga, Lowell, MA (US)

(73) Assignee: International Business Machines Corporation, Armonk, NY (US)

(21) Appl. No.: 14/078,930

(22) Filed: Nov. 13, 2013

Related U.S. Application Data
(63) Continuation of application No. 13/850,708, filed on Mar. 26, 2013.

(51) Int. Cl. H04L 12/58; H04L 12/26

(52) U.S. Cl. CPC H04L 51/32; H04L 43/08
USPC 709/206

(57) ABSTRACT

A method and a system for profiling social trendsetters on a communications network includes monitoring social networking communications on a communications network using a program executable by a computer. The program monitors social networking communications for a topic of conversation in messages by a plurality of users. The messages are analyzed for relation to the topic of conversation and for topic information based on a specified criteria. The program determines a role for each of the plurality of users based on the topic information, and indicates the roles for each of the users, respectively, and may indicate the roles and associated people pertaining to particular topics.

### CROSS REFERENCE TO RELATED APPLICATIONS

This application is a continuation of U.S. application Ser. No. 13/850,708, filed Mar. 26, 2013.

### FIELD

The present disclosure relates to a method and system for profiling social trendsetters on a communications network, and more particularly, includes indicating a social trendsetting status for a user on a social network.

### BACKGROUND

Communicative exchanges by multiple users of a forum using a communications network may be accessible by a computer or personal data assistant (PDA), and further may include, on-line chat groups, blogs, e-mails, instant messaging between users, document libraries, and social networking websites accessible using the Internet. The communicative exchanges may result in extensive accumulation of content. The content can be stored by a social networking provider or stored locally. The communication exchanges may take on a viral nature as social computing can share ideas quickly, along with an increasing scale, may result in voluminous content. For example, a topic could be initiated early by a member of the network, and other members may create content about the topic following the initiator, or independently create content. As time passes, the topic can take on a life of its own, resulting in significant conversational exchanges.

Current attempts to understanding the evolution of a topic over time may include showing a visualization of who shared a topic, and the scale of which the sharing expanded by others, based on who the topic was shared with. Other attempts to understand evolution of a topic may include identifying a contributor to a topic. While current techniques may illustrate an evolutionary history, they do not offer insightful context regarding the involvement of contributors in the evolution of an idea.

Also, without a starting point from which to view the propagation of information, such as a topic or originating person, the information lacks informative value for the user. Thus, current techniques lack valuable information, such as, information which enables a user to ascertain where and with whom a topic originated, and how the topic progressed over time.

### BRIEF SUMMARY

It would therefore be desirable for a method and system to provide valuable information pertaining to a life cycle of a topic or a topic's evolutionary history. Further, it would be desirable for a user to be able to access a history of a topic, and additionally a contributor's role in the topic evolutionary history, as well as a summary of topics in which a user has played a role of influence, which role can appear on that user's social profile.

In an aspect of the invention, a method for profiling social trendsetters on a communications network includes: monitoring social networking communications on a communications network using a program, the program being executable by a processor of a computer; analyzing the monitored social networking communications for a topic of conversation in messages by a plurality of users; analyzing the messages related to the topic of conversation for topic information based on a specified criteria; determining a role for each of the plurality of users based on the topic information; and indicating the roles for each of the users, respectively.

In another aspect of the invention, a system for profiling social trendsetters on a communications network includes a communications network having social networking communications which are monitorable using a program, and the program being executable by a processor of a computer. An analyzing module of the program is configured to analyze the monitored social networking communications for a topic of conversation in messages by a plurality of users, and the analyzing module is configured to analyze the messages related to the topic of conversation for topic information based on a specified criteria. A determining module of the program is configured to determine a role for each of the plurality of users based on the topic of information. An associating module of the program is configured to associate the role for each of the users to a user profile of a social network for each of the respective users by applying the role to the user profile. An identification of the role is indicatable on a display for each of the users on the users' profile, respectively.

In another aspect of the invention, a computer program product for profiling social trendsetters on a communications network. The computer program product comprises a computer readable storage medium having program code embodied therewith, the program code being readable/executable by a processor to perform a method including: monitoring social networking communications on a communications network using a program, the program being executable by a processor of a computer; analyzing the monitored social networking communications for a topic of conversation in messages by a plurality of users; analyzing the messages related to the topic of conversation for topic information based on a specified criteria; determining a role for each of the plurality of users based on the topic information; and indicating the roles for each of the users, respectively.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a schematic block diagram illustrating an overview of the system and methodology for profiling social trendsetters on a communications network according to an embodiment of the disclosure; and

FIG. 2 is a flow chart illustrating a method for profiling social trendsetters using the system of FIG. 1 according to an embodiment of the disclosure.

### DETAILED DESCRIPTION

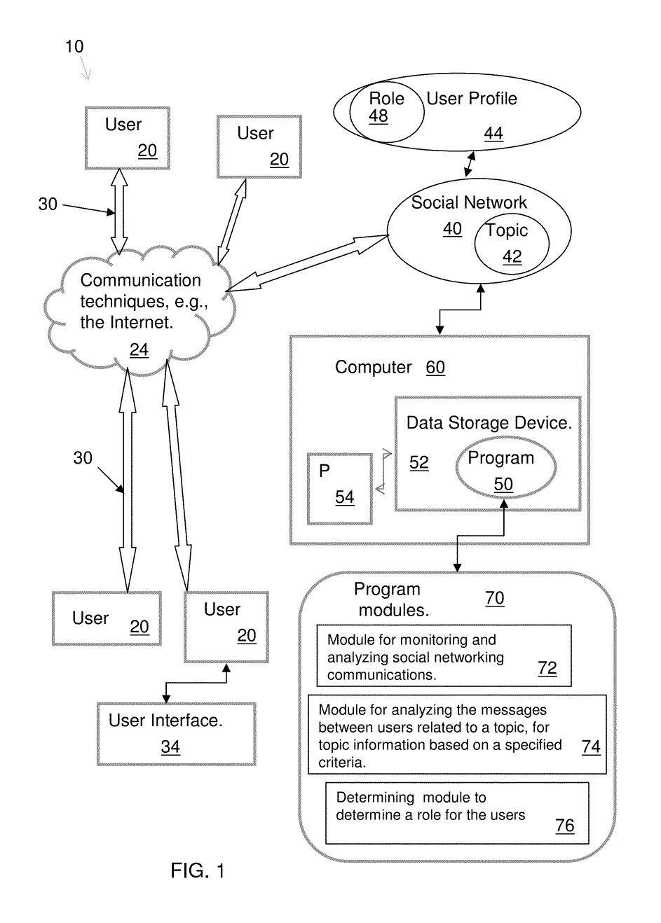

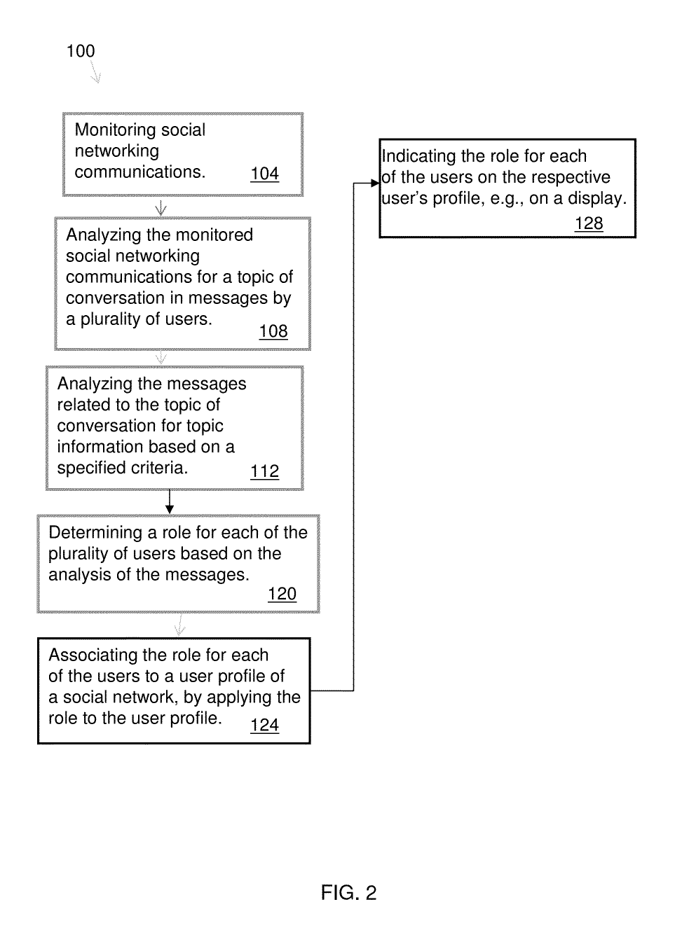

Referring to FIGS. 1 and 2, a system 10 and method 100 according to an embodiment of the disclosure for profiling social trendsetters includes a communications network 14 communicating with a plurality of users 20 wherein one of the users 20 may be an initiating user. The initiating user is a user who may be the first to initiate contact with other users. The users 20 access a social network 40 using communications techniques 24, for example, the Internet, or Ethernet based Local Area Network (LAN). The social network 40 may include an Internet based application accessible by the users 20 via a computing device such as a personal data assistant (PDA), computer, cellular telephone, which are generically represented at user interface 34. The user interface may also include a computer having a display. The social network 40 may include one or more databases for storing messages, and the database may be accessed by the program for analyzing stored messages. A program 50 is used to monitor the social network 40, as in step 104 of the method 100. The program 50 is embodied on a data storage device 52 and is executable by a processor 54 of a computer 60 to perform the method 100. The method steps and system features may be embodied in modules of the program for performing the tasks of each of the steps of the method and system, which are generically represented in FIG. 1 as program modules 70.

The computer 60 also is generically representative of a computer that the users' may have to access the Internet 24 and social network 40. The social networking communications may include: a posting, a tweet, an e-meeting, a repost, a review, a reading, a comment, a tagging, a bookmarking, a rating, an approval, or a disapproval.

Referring to FIG. 2, step 108 of the method 100 includes analyzing the monitored social networking communications for a topic 42 of conversation in messages 30 by the plurality of users 20 using a social network 40, as shown in module 72 of FIG. 1. Step 112 includes analyzing the messages 30 and the topic of conversation for topic information related to the topic of conversation based on a specified criteria, as shown in module 74 of FIG. 1. The specified criteria may include length of messages, initiation of messages, and frequency of messages. The specified criteria may also include specified topics of communication, selected users, or a user having a specified characteristic, for example, being an employee of a company or a member of a club. Using the analysis of step 112, the method determines a role for each of the plurality of users and assigns the role to the user, in step 120 of the method 100, as shown in module 76 of FIG. 1. The role may include labeling users as initiators, contributors, or an expert in a topic. A more extensive discussion of roles (or role labels) is disclosed below. The roles may also be determined after analyzing the messages 30 over a period of time, so that the determined role is based on data over the period of time. Thus, the present disclosure identifies key people in the propagation of content (for example, content related to a topic). The disclosure may also use keywords or relevance between multiple content items shared at different times by the same person to determine influence on tags or individual topics contained throughout the different content shared.

The method may monitor user engagement in a topic over time, including content creation, sharing and other activity, (e.g., participating in emeetings, calls, etc. related to the topic, etc). The user's role in the social evolution of the topic may be associated with a user's social profile of a social network. Information about other key users may be made available on the user's social profile, or when searching a particular topic. Groups within a social network can be analyzed similarly, providing similar information for a collection of users, and this information can become part of the group profile and/or shared with the independent profile of an individual user.

Step 124 includes associating the role for each of the users 20 to a user profile 44 on the social network 40 for each of the respective users by applying (or linking) a role 48 to the user profile 44. The user profile 44 and role 48 shown in FIG. 1 are representative of a plurality of the same related to the plurality of user 20. Step 128 includes indicating the role 48 for each of the users 20 on their respective user profile 44. The profile and role may be displayed on a user interface 34, or example, on a PDA, or a display connected to a computer, generically represented by the computer 60 shown in FIG. 1. The identification of the users may be updated over a time period defined by a start and an end of a communication regarding the topic.

For example, the roles that a user may be assigned or labeled on their respective profile may include and be defined as the following:

a catalyst (e.g., a user who is a first independent creator of a topic);

exposed or follower (e.g., a user who reads up to “x” amount (volume or percent) of content on a topic);

a trendspotter (e.g., a user who shares a topic early and before “x” number (or percent) of users become involved);

a trendsetter (e.g., a user who has initial involvement with a topic including sharing, content creation, before “x” number (or percent) of other users became involved);

an expert (e.g., a user who is an ongoing and/or significant contributor or consumer of content (measured in volume or percent) related to a topic); and

an incubator (e.g., a user who serves in one of the above roles related to a topic that manifested into a concrete business result such as a new product).

The method 100 and system 10 may monitor user communication for activity changes regarding the topics. An activity change may include frequency of topic discussion, which may include more frequent discussions of a topic, or infrequent discussion of a topic. Similar monitoring can be applied to changes of topics, which may include, modification, transforming, or outright changing of a topic. The method may send one or more alerts indicating the activity changes, or topic changes to the users. Such alerts can be sent to users with selected roles, that is, a change of topic alert can be sent to a catalyst but not a follower, because the catalyst of the topic may be most interested in a change of direction for the topic.

The method 100 can be implemented in various manners. A group of users from the plurality of users may be defined and labeled based on the criteria with a group role. The group label can then be linked or associated to a group profile for the group. The group label can also be linked or associated to one or more of the user profiles. In another variation, the specified criteria can be analyzed for each of the users to specify a resulting quantitative contribution for each of the users regarding each of the specified criteria. The quantitative contribution can then be used in determining the role for the user. The method of claim 1, wherein the identification of the users is updated over a time period defined by a start and an end of a communication regarding the topic.

The present disclosure may also provide additional information regarding the topic pertaining to how it could have evolved if the selected user (or group) was not engaged in the conversation. This would help in understanding how pivotal a user or group was to the expansion of an idea. In another variation, the disclosure can determine users a topic would have or would not have reached had the user or group not been involved. In the method disclosed herein, users may remove topics from their profile, to reduce exposure to unpopular, flawed, or unwanted ideas. Additionally, metrics can be provided showing a user's actual trending labels (e.g., user trendspotted 10% of new product features), compared to others of similar job roles. In one instance, the method of the present disclosure encourages people and groups to try to become influential and have that information displayed in their profile. This type of positive social gaming can contribute to a vibrant participation in the social fabric and contribution of content. In another instance, identifying when a trend becomes unpopular and when its activity contracts may also be indicated. This can be useful in understanding how to steer trends to users for maintaining the life of a topic. Knowing when a trend contracts and ascertaining the cause of a contraction may enable directing the topic to a resurgence of activity. The present method and system can monitor trends for decreased activity, and encourage users back into the conversation, such as by alerting them of the decreased activity, alerting them to questions that remained unanswered in the content, or recommend others a participant should invite to the conversation.

The method 100 may be embodied on the system 10 for profiling social trendsetters on a communications network, which includes the steps as discussed above. A monitoring and analyzing module 72 of the program 50 can be configured to analyze the monitored social networking communications for a topic of conversation in messages by a plurality of users. An analyzing module 74 analyzes the messages related to the topic of conversation for topic information based on a specified criteria. A determining module 76 of the program 50 can be configured to determine a role for each of the plurality of users based on the topic of information. An associating module of the program can be configured to associate the role for each of the users to a user profile of a social network for each of the respective users by linking the role to the user profile. An indicating module can be configured to display the role for each of the users on the users' profile. Thus, the present disclosure identifies key people in the propagation of content.

Thereby, the method and system of the present disclosure provide monitoring of a user's engagement in a topic based social conversation to identify a user's role in the topic evolutionary history. The user's role can be used indicated on a user's social profile thereby building a trendsetting profile of the user. The present disclosure enables users to ascertain important time based information regarding the social creation of ideas/topics by indicating origination, contribution, and/or influence to an idea/topic. While current techniques illustrate an evolutionary history, they do not offer insightful context regarding the involvement of pivotal contributors in the evolution of an idea, such as extracting key involvement to reflect as an attribute on a user's social profile.

The benefits of understanding the information discussed above are numerous, including knowing who early trendspotters are, as they may have a general intuition or skill in predicting the next big thing. Also, managers can use the information to identify influential/valuable employees. Also, as users contribute to an idea over time, they may become experts, and there is value in being able to reach out to experts.

While embodiments of the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

Therefore, one or more Figures described herein may illustrate a schematic of an embodiment of the disclosure and may include a representative computer system or processing system that may implement a method and a program in one or more embodiments of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with one or more processing systems in the present disclosure may include, but are not limited to, personal computer systems, server computer systems, handheld or laptop devices, multiprocessor systems, microprocessor-based systems, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units, a system memory, and a bus that couples various system components including system memory to processor. Computer system may include a variety of computer system readable media. Such media may be any available media that is accessible by computer system, and it may include both volatile and non-volatile media, removable and non-removable media. System memory 58, shown in FIG. 1, can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices such as a keyboard, a pointing device, a display, etc.; one or more devices that enable a user to interact with computer system; and/or any devices (e.g., network card, modem, etc.) that enable computer system to communicate with one or more other computing devices. Such communication can occur via Input/Output (I/O) interfaces. Additionally, computer systems can communicate with one or more networks such as a local area network (LAN), a general wide area network (WAN), and/or a public network (e.g., the Internet) via network adapter. As depicted, network adapter communicates with the other components of computer system via bus. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

Additionally, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Further, any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams as may be illustrated in the one or more Figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments, features, and instructive examples described above are illustrative, and should not be construed to limit the present disclosure to the particular embodiments or enumerated examples. Thus, various changes and modifications may be effected by one skilled in the art without departing from the spirit or scope of the disclosure as defined in the appended claims.

What is claimed is:

1. A method for profiling social trendsetters on a communications network, comprising:
monitoring social networking communications on a communications network using a program, the program being executable by a processor of a computer;
analyzing the monitored social networking communications for a topic of conversation in messages by a plurality of users;
analyzing the messages related to the topic of conversation for topic information based on a specified criteria;
determining a role for each of the plurality of users based on the topic information; and
indicating the roles for each of the users, respectively.

2. The method of claim 1, further comprising:
associating the roles for each of the users to a user profile of a social network for each of the users; and
indicating the roles on each of the users' profiles, respectively.

3. The method of claim 1, further comprising:
monitoring for activity changes regarding the topic, and
sending alerts indicating the activity changes to the users with selected roles.

4. The method of claim 1, wherein the specified criteria includes a frequency of user actions corresponding to a role definition, the role definition includes: content creator; or a frequent sharer.

5. The method of claim 1, wherein the roles include: an initiator; a contributor; an influencer; a trend setter; and a follower; of the topics over a specified time period.

6. The method of claim 1, wherein the social networking communications include: a posting, a tweet, an e-meeting, a repost, a review, a reading, a comment, a tagging, a bookmarking, a rating, an approval, and a disapproval.

7. The method of claim 1, further comprising:
defining a group of users from the plurality of users;
labeling the group of users based on the criteria with a group role; and
applying a group label to a group profile.

8. The method of claim 7, further comprising:
applying the group label to one or more of the user profiles.

9. The method of claim 1, further comprising:
analyzing the specified criteria for each of the users to specify a quantitative contribution for each of the users regarding each of the specified criteria.

10. The method of claim 1, wherein the indicating of the roles of the users is updated over a time period defined by a start and an end of a communication pertaining to the topic.
